(19) United States
(12) Patent Application Publication
(10) Pub. No.: US 2010/0012049 A1
(43) Pub. Date: Jan. 21, 2010

(54) CAVITATION HEATING SYSTEM AND METHOD

(75) Inventor: Benjamin Pless, Atherton, CA (US)

Correspondence Address: SCHOX PLC, 500 3rd Street, Suite 515, San Francisco, CA, 94107, US

(73) Assignee: JMS CO., LTD, Hiroshima (JP)

(21) Appl. No.: 12/296,525

(22) PCT Filed: Apr. 12, 2007
(86) PCT No.: PCT/US07/66508

§ 371 Date: Sep. 29, 2009

Related U.S. Application Data
(60) Provisional application No. 60/795,134, filed on Apr. 26, 2006.
(60) Provisional application No. 60/791,285, filed on Apr. 12, 2006.
(60) Provisional application No. 60/791,284, filed on Apr. 12, 2006.

(51) Int. Cl. F22B 3/06; B05B 1/34

(52) U.S. Cl. 122/26; 239/461; 126/247

(57) ABSTRACT

The cavitation heating system of the preferred embodiment includes a reservoir to contain an operating fluid, and a cavitator subsystem with an inlet to receive the operating fluid from the reservoir, a cavitator to cavitate the operating fluid, and an outlet to transfer the cavitated operating fluid to the reservoir. The cavitation of the operating fluid generates heat. The cavitation heating system may use various techniques either singly or in combination to increase the heat generated from the cavitation of the operating fluid, including: the use of oil as an operating fluid, the addition of dissolved noble gases in the operating fluid, the use of a pump to create jets that cavitate the operating fluid in a vessel and heat the operating fluid, and the use and control of pressure on the cavitation of the operating fluid.

### CROSS-REFERENCE TO RELATED APPLICATIONS

This application claims the benefit of U.S. Provisional Application No. 60/791,285 entitled “Heating Apparatus Utilizing Cavitating Jets” and filed on 12 Apr. 2006; U.S. Provisional Application No. 60/791,284 entitled “Enhanced Heating Apparatus Utilizing Cavitation Jets” and filed on 12 Apr. 2006; and U.S. Provisional Application No. 60/795,134 entitled “Heating Apparatus Utilizing Cavitation and Suspended Particles” and filed on 26 Apr. 2006, which are all incorporated in their entirety by this reference.

### TECHNICAL FIELD

This invention relates generally to heating systems, and more specifically to a new and useful cavitation heating system.

### BACKGROUND

Typically, fluids are heated by burning fossil fuels (generally coal, gas or oil) or by electricity (which is generally created by burning fossil fuels). The disadvantages of burning fossil fuels are well known, including the release of carbon dioxide that causes global warming and ocean acidification. Since more efficient methods to heat fluids would be advantageous, heating systems have been recently pursued, including cavitation heating systems.

Cavitation is the formation of bubbles within a fluid when that fluid reaches its vapor pressure. In some ways, cavitation is similar to boiling. The major difference between the two is the thermodynamic paths that precede the formation of the vapor. Boiling occurs when the local vapor pressure of the liquid rises above its local ambient pressure and sufficient energy is present to cause the phase change to a gas. Cavitation inception occurs when the local pressure falls sufficiently far below the saturated vapor pressure, a value given by the tensile strength of the liquid. Cavitation inception can occur, for example, behind the blade of an impellor, in the nozzle of a cavitation jet, or through the shearing of a fluid as one portion rapidly passes another portion. Since cavitation bubbles have a relatively low gas pressure, the bubble will collapse in the presence of a higher pressure in the surrounding fluid. As the bubble collapses, the pressure and temperature of the vapor within the bubble will increase. The bubble will eventually collapse to a minute fraction of its original size, at which point the gas within dissipates into the surrounding liquid via a rather violent energy release. At the point of total collapse, the temperature of the vapor within the bubble may be several thousand degrees Kelvin, and the pressure several hundred atmospheres. Cavitation heating is based on the capture of the violent energy release.

In U.S. Pat. No. 5,659,173 entitled “Converting acoustic energy into useful other energy forms” and issued to Putterman on 19 Aug. 1997, Putterman discloses a method of converting acoustic energy into a heat energy by creating a gaseous bubble in a liquid in a container, locating the bubble in a liquid under the action of acoustic energy applied to the liquid, and compressing and decompressing the bubble under the action of resonating pressure applied to the liquid by the acoustic energy. The Putterman patent is hereby incorporated in its entirety by this reference.

In U.S. Pat. No. 5,239,948 entitled “Heat exchange system utilizing cavitating fluid” and issued to Sajewski on 31 Aug. 1993, Sajewski discloses a heat exchange system that includes a pulsating fluid directed into a vessel at such frequency pressures and temperatures that it cavitates within the vessel and generates heat. The Sajewski patent is hereby incorporated in its entirety by this reference. The Sajewski patent, however, teaches that the bubbles, which implode upon contact with a metal surface, are also used to remove scales and self-clean the vessel of the heat exchange system. As Sajewski admits, the implosion of the bubbles can pit or damage metal surfaces (which is why cavitation is typically avoided in conventional fluid systems). The heat exchanger system of the Sajewski patent, therefore, must withstand these damaging implosions.

In U.S. Pat. No. 6,910,448 entitled “Apparatus and method for heating fluids” and issued to Thoma on 28 Jun. 2005, Thoma discloses a fluid heating device with a rotor in a chamber, wherein rotation of the rotor causes openings in the outer surface of the rotor to impart heat-generating cavitation to a fluid entering the internal chamber. The Thoma patent, however, teaches a fairly chaotic system with essential parts moving very close to the creation of the shockwaves, which—again—must withstand these damaging implosions.

Thus, there is a need in the heating systems field to create an improved cavitation heating system. This invention provides such improved cavitation heating system.

### BRIEF DESCRIPTION OF THE FIGURES

FIG. 1 is schematic representation of the cavitation heating system of the preferred embodiment.

FIGS. 2 and 3 are detailed views of a cavitator subsystem.

FIG. 4 is a schematic representation of a heat exchanger.

FIGS. 5 and 6 are schematic representation of a first variation and a second variation, respectively, of the means for pressurization.

FIGS. 7 and 8 are schematic representation of the preferred embodiment and an alternative embodiment, respectively.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

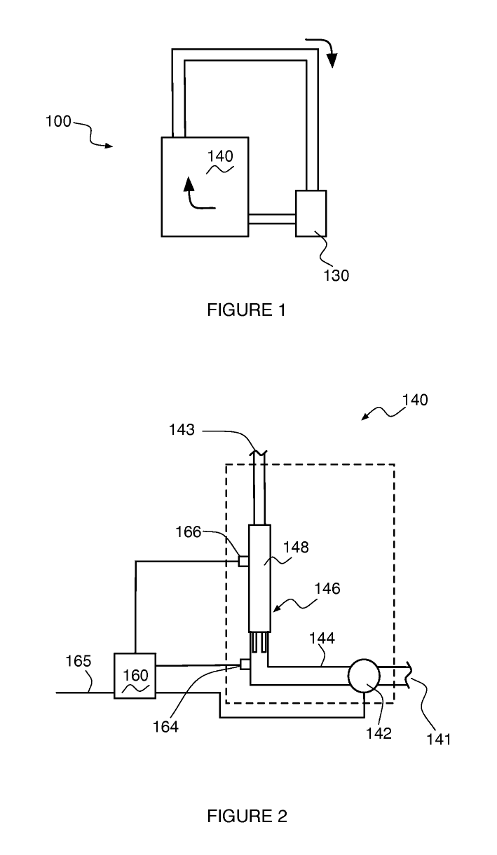

As shown in FIG. 1, the cavitation heating system 100 of the preferred embodiment of the invention includes a reservoir 130 to contain an operating fluid, and a cavitator subsystem 140 with an inlet to receive the operating fluid from the reservoir 130, a cavitator to cavitate the operating fluid, and an outlet to transfer the cavitated operating fluid to the reservoir 130. The cavitation of the operating fluid generates heat. The cavitation heating system 100 may use various techniques either singly or in combination to increase the heat generated from the cavitation of the operating fluid, including: the use of oil as an operating fluid, the addition of dissolved noble gases in the operating fluid, the use of one or more cavitation jets that cavitate the operating fluid in a vessel and heat the operating fluid, and the use and control of pressure on the cavitation of the operating fluid.

### 1. Operating Fluid and Reservoir

The operating fluid of the preferred embodiment functions as a medium to receive kinetic energy and transmit thermal energy upon cavitation. In general, a suitable operating fluid is one that releases a lot of energy when cavitating and can withstand high operating temperatures. The operating fluid is preferably oil, such as paraffinic oil or machine oil. Oil is difficult to cavitate and as a result greater heat is released during cavitation than if a fluid like water, which is comparatively easy to cavitate, were used. This principle may be advantageously employed in any apparatus that creates cavitation to heat a fluid. Furthermore, oil can be operated at temperatures of 200 degrees centigrade (and higher) so the cavitator subsystem 140 may be operated at temperatures above the boiling point of water resulting in effective heat transfer from the operating fluid. In the alternative, many other fluids including water may be a suitable operating fluid depending on the application of the device.

The operating fluid of the preferred embodiment includes dissolved gases to augment the temperature rise during the cavitation. Noble gases (including Helium, Neon, Argon, Krypton, and Xenon) alone or mixed with other gases are preferred. Xenon is particularly effective in increasing the temperature achieved during cavitation, but argon may be preferred since it is less expensive. Actively mixing the gas with the operating fluid 110 may be desirable in some circumstances, and that such mixing could be accomplished with stirring rods, propellers, sprays, or other suitable methods or devices

The reservoir 130 of the preferred embodiment functions to contain the operating fluid before the operating fluid is drawn into the cavitator subsystem 140. The reservoir 130 is preferably a relatively large tank, but may be indistinguishable from other pipes or conduits in the cavitation heating system 100.

### 2. Cavitator Subsystem

The cavitator subsystem 140 of the preferred embodiment functions to cavitate the operating fluid. The cavitator subsystem 140 preferably includes an inlet 141 connected to the reservoir 130 to receive the operating fluid from the reservoir 130, a cavitator to cavitate the operating fluid, and an outlet 143 connected to the reservoir 130 to transfer the cavitated operating fluid to the reservoir 130.

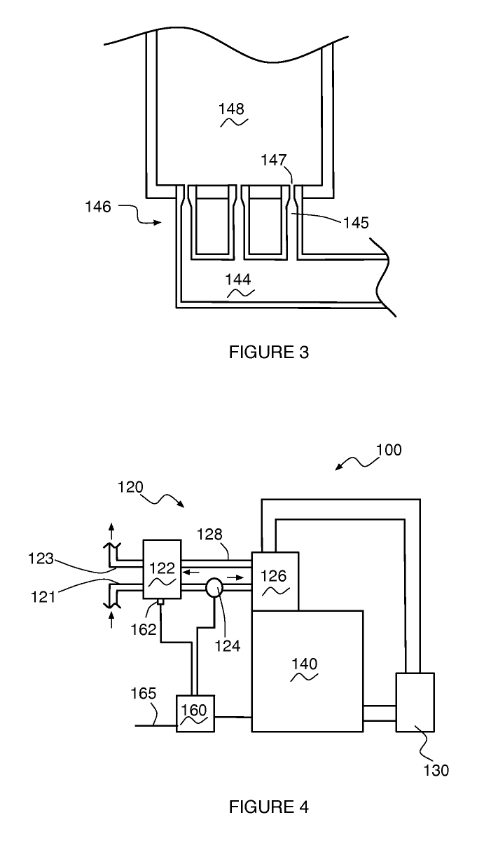

In a first variation, as shown in FIGS. 2 and 3, the cavitator subsystem 140 includes a cavitating jet 146 and a hydraulic pump 142. The cavitating jet 146, which is preferably located between the inlet 141 and the outlet 143, functions to cavitate the operating fluid. The cavitating jet 146 preferably includes a throat 145, a nozzle 147, and a reactor vessel 148. The throat 145 and the nozzle 147 cooperate to receive the operating fluid from the hydraulic pump 142 and to increase the velocity of the operating fluid. Many different geometries for the transition from the throat 145 to the nozzle 147 may be used, but in the preferred geometry is a linear taper. The diameter of the nozzle 147 is preferably one sixteenth of an inch, while the diameter of the throat 145 is one and a half inches. The cavitating jets 146 may, however, include other geometries and dimensions, such as the cavitating jets 146 disclosed in U.S. Pat. No. 5,125,582 entitled “Surge Enhanced Cavitating jet” and issued to Surjaatmadja on 30 Jun. 1992 and U.S. Pat. No. 6,200,486 entitled “Fluid Jet Cavitation Method and System for Efficient Decontamination of Liquids” and issued to Chahine on 13 Mar. 2001, which are both incorporated in their entirety by this reference. The reactor vessel 148, which is located between the nozzle 147 and the outlet 143, functions to contain a portion of the operating fluid and facilitate cavitation of the operating fluid. The reactor vessel 148 is preferably fabricated as a closed bottom cylinder. The reactor vessel 148 is preferably made with steel walls, but may alternatively be made with other materials. The throat 145, the nozzle 147, and the reactor vessel 148 preferably cooperate to cavitate the operating fluid through a venturi effect and/or a shearing effect of the high-velocity operating fluid exiting the nozzle 147 against the relatively static operating fluid within the reactor vessel 148. In both cases, the pressure of a volume of the operating fluid drops below the vapor pressure of the operating fluid, thereby cavitating the operating fluid. When the cavitation bubbles in the operating fluid eventually collapse, shockwaves and heat are generated. The collapse of the bubbles and the creation of the shockwaves preferably occurs at a distance from the walls of the reactor vessel to minimize damage to the reactor vessel. The cavitator subsystem 140 preferably includes multiple cavitating jets 146 are preferably welded into the bottom of the reactor vessel 148, or alternatively screwed, clamped, bolted or otherwise affixed to the reactor vessel 148.

The hydraulic pump 142, which is preferably located between the inlet 141 and the cavitating jet 146, functions to increase the pressure of the operating fluid on an upstream side of the cavitating jet 146. The pump is preferably an electric pump, having approximately 5-10 horsepower, but any pump may be used including pumps directly driven from a mechanical source such as wind, hydraulic or wave power, or from an internal combustion engine.

The cavitator subsystem 140 of the first variation also includes a plenum 144 and a return conduit 149. The plenum 144, which is located between the hydraulic pump 142 and the cavitating jet 146, functions to contain the operating fluid at a suitable pressure to drive the cavitating jet 146. Operating pressure in the plenum 144 is preferably between 500 and 5000 pounds per square inch (psi), but other pressures may be used depending on the design of the cavitation jets 146, and other aspects of the cavitation heating system 100. The return conduit 149 functions to transport the operating fluid from the reactor vessel 148 to the reservoir 130. The reactor vessel 148 is preferably distinct from the return conduit 149, but it is possible for the two to be formed of a continuous length of pipe with no clear boundary between them.

In a second variation, the cavitator subsystem 140 includes a propeller and a motor. In a third variation, the cavitator subsystem 140 includes a rotor and a motor, similar to the invention of U.S. Pat. No. 6,910,448 entitled “Apparatus and Method for Heating Fluids” and issued to Thoma on 28 Jun. 2005, which is hereby incorporated in its entirety by this reference. In a fourth variation, the cavitator subsystem 140 includes pulsed-valves and a pump, similar to the invention of U.S. Pat. No. 5,239,948 entitled “Heat Exchange System Utilizing Cavitating Fluid” and issued to Sajewski on 31 Aug. 1993, which is hereby incorporated in its entirety by this reference. In other variations, the cavitator subsystem includes any suitable method or device to cavitate the operating fluid.

### 3. Additional Elements

As shown in FIG. 4, the cavitation heating system 100 of the preferred embodiment further includes a heat exchanger 120. The heat exchanger 120 functions to transfer heat from the cavitated operating fluid to a target fluid. The heat exchanger 120 is preferably located adjacent or surrounding the reactor vessel, but may be located or arranged in any suitable location or manner to transfer heat from the cavitated operating fluid. Preferably, the target fluid is water. The water is preferably stored in a target fluid reservoir 122. Cold water is preferably introduced into the hot fluid reservoir 122 through an intake pipe 121, and hot water or steam is extracted through an exhaust pipe 123. Water that needs to be heated is moved from the target fluid reservoir 122 by a pump 124 to the heat exchanger 120. Heated water or steam returns from the heat exchanger 120 to the target fluid reservoir 122 through a pipe 128. The heat exchanger 120 may simply be a coil of copper tubing 126 installed inside the vessel 148 through which the target fluid is induced to flow by the action of the pump 124. The heat exchanger 120 may include any other suitable method or device. Although the heat exchanger preferably transfers heat to water, the target fluid may be any other suitable fluid, mixture, or slurry. In one example, a target fluid having a low vapor pressure may be employed such that the heated target fluid is boiled and the resultant gas may be used to drive a turbine or for other mechanical work. In another example, the target fluid may be a gas, for example room air if the device is used to heat air directly.

As shown in FIGS. 2 and 4, the cavitation heating system 100 of the preferred embodiment further includes a controller 160. The controller 160, which is connected to the cavitator subsystem 140 and to the heat exchanger 120, functions to regulate the temperature of the target fluid in the target fluid reservoir 122 through the regulation of the cavitation of the operating fluid. The controller preferably monitors the temperature of the target fluid through an electronic thermometer 162 mounted to the target fluid reservoir 122 (for example the Model 1500 series transducers from Spectre Sensors, Inc.). If the temperature of the target fluid is too cool, the controller 160, which receives electrical power from a power cord 165, energizes the hydraulic pump 142 by applying a variable voltage. Once the temperature of the target fluid in the target fluid reservoir 122 is hot enough, the controller 160 preferably shuts off the pumps 142 and 124. The controller 160 also preferably monitors the pressure of the operating fluid in the plenum 144 through an electronic pressure monitor 164 mounted to the plenum 144 (for example the FP2000 series transducers from RDP Electronics, LTD). The cavitating jet 146 requires a particular pressure range (approximately 1000 to 2000 psi in the preferred embodiment) to cavitate the operating fluid. The controller 160 adjusts the voltage until the pressure in the plenum 144 is in the correct range for the cavitating jets 146 to cavitate the operating fluid. In an alternative embodiment, the cavitation heating system 100 could be operated simply by energizing the pumps 142 and 124 or by any other suitable method or device.

The controller may also monitor the temperature of the operating fluid in the vessel 148 through an electronic thermometer 166 mounted to the reactor vessel 148. Once the temperature in the reactor vessel 148 is hotter than the temperature in the target fluid reservoir 122, the controller energizes pump 124 to allow heat exchange from the operating fluid to the target fluid through the heat exchanger 120. While this sequence is not critical for operation, it does prevent heat transfer from the target fluid reservoir 122 to the reactor vessel 148 if the target fluid reservoir 122 happens to be at a higher temperature than the reactor vessel 148.

In the preferred embodiment, the cavitation heating system 100 further includes means for pressurizing the contents of the vessel 148, which functions to generate further heat during the cavitation. The pressurizing means is preferably independent of the cavitator subsystem 140. The pressurizing means preferably includes a valve 150 adapted to adjust the pressure of the operating fluid on a downstream side of the nozzle 147.

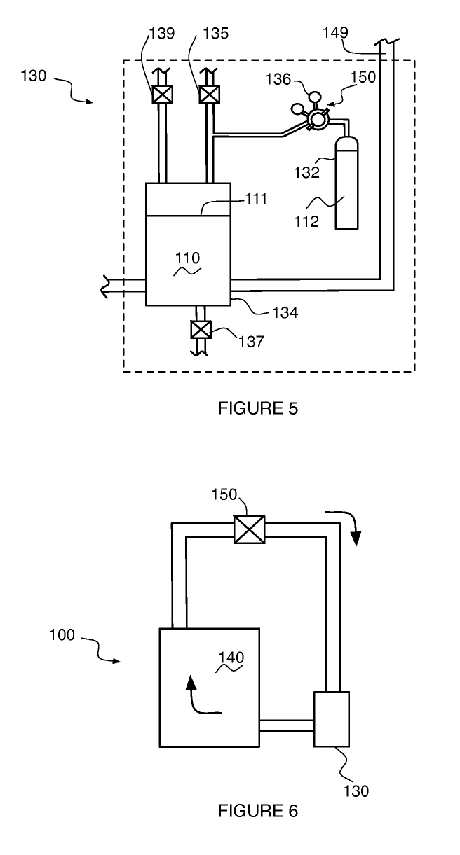

In a first variation, as shown in FIG. 5, the cavitation heating system 100 of preferred embodiment pressurizes the reactor vessel 148 and facilitates control the gas dissolved in the operating fluid 110. To expose gases to the operating fluid 110, a pressurized gas source 132 is preferably connected to the operating fluid chamber 134. The pressurized gas source 132 is preferably a bottle of compressed gas 112. The valve 150 is preferably a gas valve 150 that allows gas pressure to be applied to the operating fluid chamber 134. The gas displaces the operating fluid 110, which results in a gas-fluid interface 111 and facilitates the dissolving of the gas 112 into the operating fluid 110. The pressure in the operating fluid chamber 134 can be monitored by a gauge or, more preferably, can be monitored through an electronic gauge 136 by the controller. Since the operating fluid chamber 134 is in communication with the reactor vessel 148 through the return conduit 149, the pressure in both is about the same. Adjusting the gas pressure through valve 150 to pressures greater than 25 psi can significantly increase heating during cavitation. The preferred pressure in this embodiment is on the order of 50 psi. The pressure in the bottle of compressed gas 112 is typically about 2000 psi if the bottle has recently been filled. Valve 135 allows the pressure in operating fluid chamber 134 to be released if it is too high.

In a second variation, as shown in FIG. 6, the valve 150 is a variable valve 150 located between the reaction vessel of the cavitation subsystem 140 and the reservoir 130. With the variable valve 150 completely open, the pressure in the reaction vessel would be relatively low. With the variable valve 150 partially closed (which increases the flow resistance into the return conduit 149), the pressure in the reaction vessel could be increased and adjusted. The variable valve 150 creates a pressure differential between the reactor vessel of the cavitation subsystem 140 and the reservoir 130. The controller 160 may also monitor the pressure of the operating fluid in the reactor vessel through an electronic pressure gauge mounted to the reactor vessel. The controller preferably adjusts the variable valve 150 to increase or decrease the pressure within the reactor vessel to achieve a target pressure.

In alternative embodiments, the means for pressurizing the contents of the vessel 148, which functions to generate further heat during the cavitation, may be accomplished with any other suitable device or method. For example, a hydraulic pump may be coupled to the reactor vessel and arranged to increase pressure in the reactor vessel.

In the preferred embodiment, the cavitation heating system 100 further includes thermal insulation to limit the amount of heat lost to the environment and to maximize the amount of heat transferred to the target fluid through the heat exchanger 120. Preferably, the cavitation subsystem (including the pump 142, the plenum 144, the vessel 148, the return conduit 149), and the reservoir 120 include thermal insulation.

### 4. Operation of the Cavitation Heating System

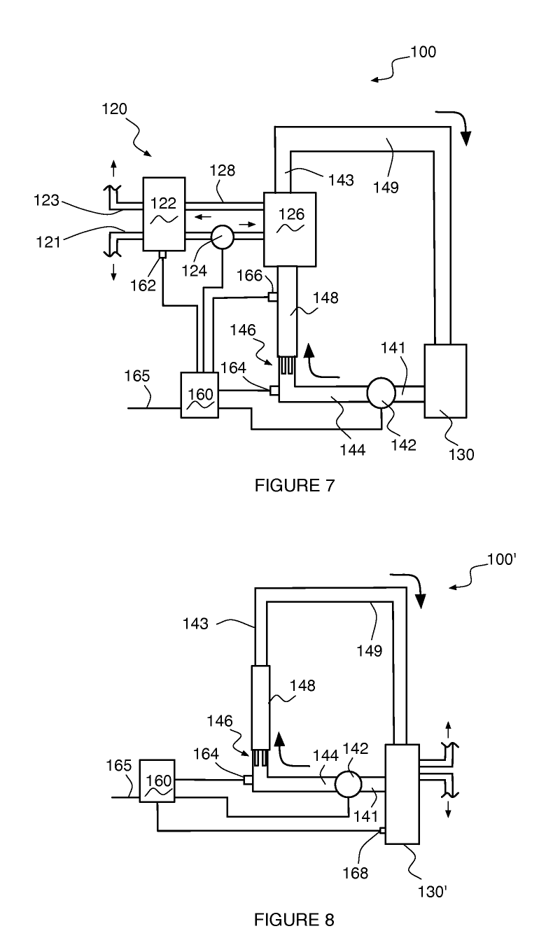

As shown in FIG. 7, the preferred cavitation heating method includes the following steps: increasing the pressure of the operating fluid in the plenum 144; injecting the operating fluid at high velocity into the vessel 148, causing the operating fluid to cavitate and generate shockwaves that heat the operating fluid contained in the vessel 148; transferring heat from the operating fluid to a target fluid; and returning the operating fluid to a reservoir 130 to repeat the cycle.

In this preferred method, the reservoir 130 and the cavitator subsystem 140 cooperate to form a substantially closed circuit for the operating fluid. In other words, the operating fluid, while subjected to pressure increase and heat transfer, preferably does not enter or exit the cavitation heating system 100 during normal use. Despite the closed circuit, the cavitation heating system 100 preferably includes valves to fill and drain the operating fluid before and after operation of the cavitation heating system 100. For example, the operating fluid chamber 134 can be drained by opening the drain valve 137, and can be filled by pumping new operating fluid through fill valve 139. Drain valve 137 and fill valve 139 preferably remain closed during operation.

As shown in FIG. 8, an alternative cavitation heating method includes the following steps: increasing the pressure of the operating fluid in the plenum 144; injecting the operating fluid at high velocity into the vessel 148, causing the operating fluid to cavitate and generate shockwaves that heat the operating fluid contained in the vessel 148; and transmitting the heated operating fluid to a remote location.

In this alternative method, the reservoir 130′ and the cavitator subsystem 140 cooperate to form a substantially open circuit for the operating fluid. In other words, the operating fluid enters and exits the cavitation heating system 100′ during normal use and the operating fluid and the target fluid are the same. While many fluids may be used, the fluid of this example is water. The fluid is stored in a fluid reservoir 130′, while cold water is introduced into the reservoir 130′ through a lower pipe, and hot water or steam is extracted through an upper pipe. In this example, the controller 60 receives pressure and temperature inputs to decide when to activate the hydraulic pump of the cavitation subsystem 140. The controller 60 operates to regulate the temperature of the fluid in the reservoir 130′ by monitoring an electronic thermometer 168 (for example the Model 1500 series transducers from Spectre Sensors, Inc.). In all other respects, the cavitation heating system 100′ of the alternative system and method is similar to the cavitation heating system 100 of the preferred system and method.

As a person skilled in the art will recognize from the previous detailed description and from the figures and claims, modifications and changes can be made to the preferred embodiments of the invention without departing from the scope of this invention defined in the following claims.

I claim:

1. A cavitation heating system comprising:
a reservoir adapted to contain an operating fluid; and
a cavitator subsystem with an inlet coupled to the reservoir and adapted to receive the operating fluid from the reservoir, a cavitator adapted to cavitate the operating fluid, and an outlet coupled to the reservoir and adapted to transfer the cavitated operating fluid to the reservoir.

2. The cavitation heating system of claim 1 further comprising the operating fluid.

3. The cavitation heating system of claim 2 wherein the operating fluid is oil.

4. The cavitation heating system of claim 2 further comprising a gas dissolved in the operating fluid.

5. The cavitation heating system of claim 4 wherein the gas is selected from the group consisting of Helium, Neon, Argon, Krypton, and Xenon.

6. The cavitation heating system of claim 1 wherein the cavitator subsystem includes a cavitating jet located between the inlet and the outlet and adapted to cavitate the operating fluid, and a pump located between the inlet and the cavitating jet and adapted to increase the pressure of the operating fluid on an upstream side of the cavitating jet.

7. The cavitation heating system of claim 6 wherein the cavitating jet includes a nozzle adapted to increase the velocity of the operating fluid.

8. The cavitation heating system of claim 7 wherein the cavitating jet further includes a plurality of nozzles located between the inlet and the outlet and adapted to increase the velocity of the operating fluid.

9. The cavitation heating system of claim 7 wherein the cavitating jet further includes a reactor vessel adapted to facilitate cavitation of the operating fluid.

10. The cavitation heating system of claim 6 wherein the cavitator subsystem further includes a plenum located between the pump and the cavitating jet and adapted to contain the operating fluid at an increased pressure.

11. The cavitation heating system of claim 6 further comprising a controller coupled to the pump and adapted to control the pressure of the operating fluid and thus the cavitation of the operating fluid.

12. The cavitation heating system of claim 1 further comprising a heat exchanger adapted to transfer heat from the cavitated operating fluid to a target fluid.

13. The cavitation heating system of claim 12 wherein the heat exchanger is coupled to the cavitator subsystem.

14. The cavitation heating system of claim 12 further comprising a controller coupled to the cavitator subsystem and to the heat exchanger and adapted to control the cavitation of the operating fluid and control the transfer of the heat from the cavitated operating fluid.

15. The cavitation heating system of claim 1 further comprising means for pressurizing the operating fluid independent of the cavitator subsystem.

16. The cavitation heating system of claim 1 further comprising a valve adapted to adjust the pressure of the operating fluid on a downstream side of the cavitator subsystem.

17. The cavitation heating system of claim 16 further comprising pressurized gas coupled to the reservoir and adapted to pressure the operating fluid in the reservoir and to dissolve into the operating fluid, wherein the valve is coupled to the pressurized gas and adapted to restrict flow of the gas into the reservoir, and further comprising a controller coupled to the valve and adapted to control the valve and thereby control the pressure of the operating fluid within the reservoir.

18. The cavitation heating system of claim 16 wherein the valve is located between the cavitator subsystem and the reservoir and is further adapted to create a pressure differential between the operating fluid at the outlet of the cavitator subsystem and the operating fluid within the reservoir.

19. The cavitation heating system of claim 18 further comprising a controller coupled to the valve and adapted to control the pressure differential.

20. The cavitation heating system of claim 1 wherein the reservoir and the cavitator subsystem cooperate to form a closed circuit for the operating fluid.

21. A cavitation heating system comprising:
a reservoir adapted to contain an operating fluid;
a cavitator subsystem with an inlet coupled to the reservoir and adapted to receive the operating fluid from the reservoir, an outlet coupled to the reservoir and adapted to transfer the operating fluid to the reservoir, wherein the reservoir and the cavitator subsystem cooperate to form a closed circuit for the operating fluid, a cavitating jet located between the inlet and the outlet and adapted to cavitate the operating fluid, and a pump located between the inlet and the cavitating jet and adapted to increase the pressure of the operating fluid on the upstream side of the cavitating jet;
a valve adapted to adjust the pressure of the operating fluid on a downstream side of the cavitating jet;
a heat exchanger adapted to transfer heat from the cavitated operating fluid to a target fluid; and
a controller coupled to the pump and adapted to control the pressure of the operating fluid on an upstream side of the cavitating jet, coupled to the valve and adapted to control the pressure of the operating fluid on the downstream side of the cavitating jet, and coupled to the heat exchanger and adapted to control the transfer of the heat from the cavitated operating fluid.

22. The cavitation heating system of claim 21 further comprising pressurized gas coupled to the reservoir and adapted to pressure the operating fluid in the reservoir and to dissolve into the operating fluid, wherein the valve is coupled to the pressurized gas and adapted to restrict flow of the gas into the reservoir, and wherein the controller is coupled to the valve and adapted to control the valve and thereby control the pressure of the operating fluid within the reservoir.

23. The cavitation heating system of claim 21 wherein the valve is located between the cavitator subsystem and the reservoir and is further adapted to create a pressure differential between the operating fluid at the outlet of the cavitator subsystem and the operating fluid within the reservoir.

24. A cavitation heating method comprising the steps of:
containing an operating fluid;
cavitating the operating fluid;
transferring heat from the cavitated operating fluid to a target fluid; and
defining a closed circuit for the operating fluid.

25. The cavitation heating method of claim 24 further comprising the steps of dissolving a gas in the operating fluid.
